(19) United States
(12) Patent Application Publication
(10) Pub. No.: US 2017/0021829 A1
(43) Pub. Date: Jan. 26, 2017

(54) VEHICLE CONTROL DEVICE

(71) Applicant: TOYOTA JIDOSHA KABUSHIKI KAISHA, Toyota-shi (JP)

(72) Inventor: Motoki NISHIMURA, Susono-shi (JP)

(73) Assignee: TOYOTA JIDOSHA KABUSHIKI KAISHA, Toyota-shi (JP)

(21) Appl. No.: 15/211,751

(22) Filed: Jul. 15, 2016

(30) Foreign Application Priority Data
Jul. 21, 2015 (JP) 2015-144099

(51) Int. Cl. B60W 30/09; B60Q 1/44; B60W 10/18; G05D 1/02; B60W 10/30; B60W 30/095; B62D 6/00; G05D 1/00; B60Q 1/34; B60W 10/20

(52) U.S. Cl. CPC B60W 30/09; B60Q 1/346; B60Q 1/44; B60W 10/18; B60W 10/20; B60W 10/30; B60W 30/0956; B62D 6/00; G05D 1/0055; G05D 1/0088; G05D 1/0214; B60W 2400/00; B60W 2550/10; B60W 2710/18; B60W 2710/20

(57) ABSTRACT

In a vehicle control device, detection of an object around a vehicle is performed, in a case where it is determined that there is a possibility that the vehicle may collide with the object, whether or not a collision can be avoided by braking control of the vehicle is determined, and in a case where it is determined that a collision cannot be avoided by the braking control, steering and braking control to avoid a collision by both steering of the vehicle and braking of the vehicle is performed, flashing of a direction indicator is started, and in a case where the vehicle has stopped, flashing of hazard flashing indicators is performed.

### TECHNICAL FIELD

The present disclosure relates to a vehicle control device for controlling a vehicle so as to avoid a collision between the vehicle and an object.

### BACKGROUND

In the related art, with regard to collision avoidance between a vehicle and an object, for example, a device described in Japanese Unexamined Patent Publication No. 2009-015547 is known. This device detects an object which may collide with a vehicle and instructs, in a case where such an object has been detected, a steering direction of the vehicle to a driver in order to avoid a collision with the object.

### SUMMARY

Incidentally, a device is conceivable which allows, in a case where an object which may collide with the vehicle has been detected, a vehicle to avoid a collision with the object by vehicle control which includes steering control of the vehicle. In such an emergency avoidance situation, it is desirable to inform the surroundings of the vehicle of a steering direction of the vehicle by the vehicle control.

Therefore, in this technical field, there is a demand for the development of a vehicle control device in which it is possible to appropriately inform the surroundings of a vehicle of a steering direction of the vehicle in a case of performing vehicle control which includes steering control for avoiding a collision between the vehicle and an object.

That is, according to an aspect of the present disclosure, there is provided a vehicle control device configured to include: an object detection unit configured to detect an object around a vehicle; a collision determination unit configured to determine whether or not there is a possibility that the vehicle may collide with the object detected by the object detection unit; a braking avoidance determination unit configured to determine whether or not a collision can be avoided by braking control of the vehicle, based on a detection result of the object detection unit and a vehicle speed of the vehicle, in a case where a determination that there is a possibility that the vehicle may collide with the object is made by the collision determination unit; a driving control unit configured to perform the braking control in a case where a determination that the collision can be avoided by the braking control is made by the braking avoidance determination unit, and to perform steering and braking control to avoid the collision by both steering of the vehicle and braking of the vehicle, in a case where a determination that the collision cannot be avoided by the braking control is made by the braking avoidance determination unit; and a lighting control unit configured to start flashing of a direction indicator of the vehicle corresponding to a steering direction of the steering and braking control in a case where a determination that the collision cannot be avoided by the braking control is made by the braking avoidance determination unit, and to flash hazard flashing indicators of the vehicle in a case where the vehicle has been stopped by the steering and braking control. According to the vehicle control device, in a case where it is determined that a collision cannot be avoided by only the braking control, the steering and braking control to avoid a collision by both the steering and the braking of the vehicle is performed and flashing of a direction indicator is started in accordance with a steering direction of the steering and braking control, and in a case where the vehicle has been stopped by the steering and braking control, hazard flashing indicators are flashed. Therefore, it is possible to inform the surroundings of the vehicle of the steering direction of the vehicle through the flashing of the direction indicator, and it is possible to inform the surroundings of the vehicle that the vehicle is in an emergency stop, through the flashing of the hazard flashing indicators.

Further, in the vehicle control device according to the aspect of the present disclosure, the vehicle control device may further include a traveling plan generation unit configured to generate a target pathway for avoiding a collision of the vehicle with the object, within a lane on which the vehicle is traveling, in a case where a determination that the collision cannot be avoided by the braking control is made by the braking avoidance determination unit, in which the driving control unit may be configured to perform the steering and braking control in accordance with the target pathway. In this case, by performing the steering and braking control in accordance with the target pathway generated within the lane, driving of the vehicle while avoiding contact with a vehicle which is being driven on a neighboring lane becomes possible.

Further, in the vehicle control device according to the aspect of the present disclosure, the vehicle control device may further include a display control unit configured to cause steering display corresponding to a steering direction of the steering and braking control by the driving control unit to be displayed on a display in the vehicle in a case where a determination that the collision cannot be avoided by the braking control is made by the braking avoidance determination unit. In this case, the steering display corresponding to the steering direction of the steering and braking control is performed, and therefore, the driver can become aware of a steering control situation of the vehicle, and thus it is possible to suppress a sense of discomfort due to the steering and braking control for the behavior of the vehicle.

According to the present disclosure, in a case of performing vehicle control which includes steering control for avoiding a collision between a vehicle and an object, it is possible to appropriately inform the surroundings of the vehicle of a steering direction of the vehicle.

### BRIEF DESCRIPTION OF THE DRAWINGS

FIG. 1 is a block diagram showing an outline of the configuration of a vehicle control device according to an embodiment of the present disclosure.

FIG. 2 is a flowchart showing control processing in the vehicle control device of

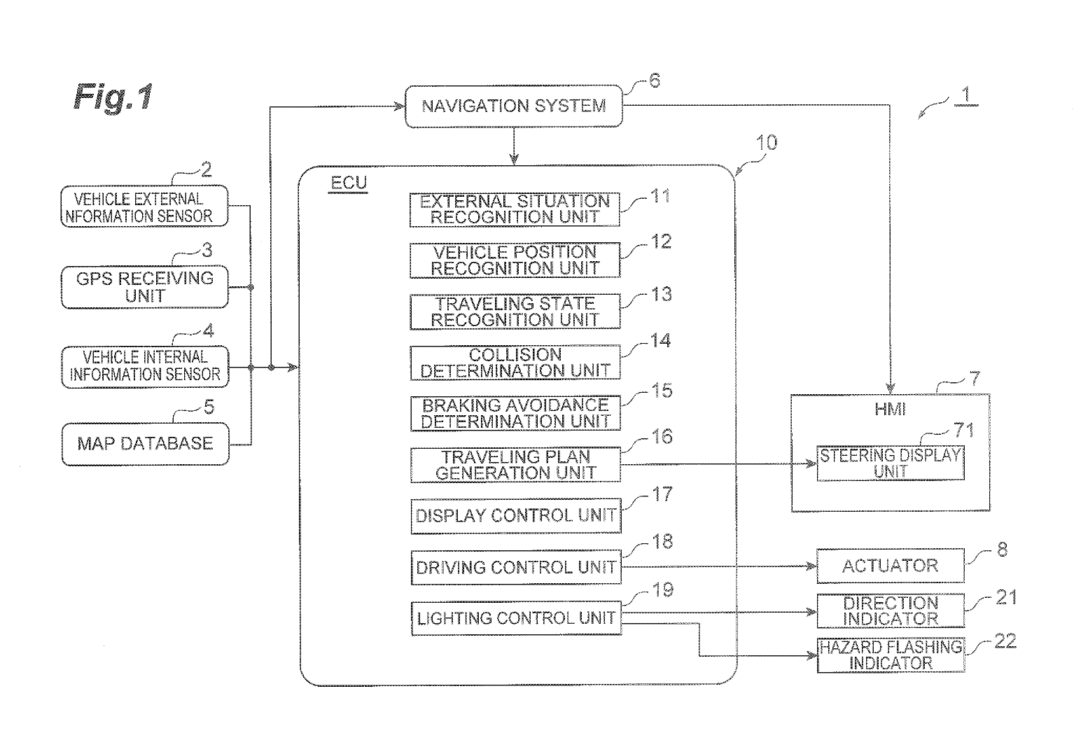

FIG. 1.

FIG. 3 is an explanatory diagram showing a vehicle state and the like in steering control and braking control in the vehicle control device of FIG. 1.

### DETAILED DESCRIPTION

Hereinafter, an embodiment of the present disclosure will be described with reference to the drawings. In addition, in the following description, the same or equivalent elements are denoted by the same reference numerals, and overlapping description is omitted.

FIG. 1 is a diagram showing an outline of the configuration of a vehicle control device 1 according to an embodiment of the present disclosure. In FIG. 1, the vehicle control device 1 according to this embodiment is a device which is mounted on a vehicle and automatically performs braking control or steering and braking control of the vehicle in order to avoid a collision between the vehicle and an object of the surroundings. Here, the steering and braking control is control which performs both steering control and braking control of the vehicle, and is control for avoidance of a collision with an object. For example, in a case where a collision between the vehicle and an object of the surroundings can be avoided by only the braking control, the vehicle control device 1 performs collision avoidance by only the braking control. In a case where a collision cannot be avoided by only the braking control, the vehicle control device 1 performs the steering and braking control of the vehicle. Further, the vehicle control device 1 performs flashing of a direction indicator of the vehicle in accordance with a steering direction of the steering and braking control and flashes a hazard flashing indicator of the vehicle in a case where the vehicle has been stopped by the steering and braking control.

The vehicle control device 1 is provided with an ECU [Electronic Control Unit] 10. The ECU 10 is an electronic control unit which performs vehicle control which includes the braking control or the steering and braking control of the vehicle, and is configured mainly with a computer which includes a CPU [Central Processing Unit], a ROM [Read Only Memory], and a RAM [Random Access Memory]. The details of the ECU 10 will be described later.

A vehicle external information sensor 2, a GPS [Global Positioning System] receiving unit 3, a vehicle internal information sensor 4, a map database 5, a navigation system 6, an HMI [Human Machine Interface] 7, an actuator 8, a direction indicator 21, and a hazard flashing indicator 22 are connected to the ECU 10.

The vehicle external information sensor 2 is detection equipment which detects an external situation that is information about the surroundings of the vehicle. The vehicle external information sensor 2 includes at least one of a camera, a radar, and a LIDAR [Laser Imaging Detection and Ranging]. The camera is imaging equipment which images an external situation of the vehicle.

The camera of the vehicle external information sensor 2 functions as a detector which detects an object around the vehicle, and transmits imaging information about the imaged object to the ECU 10. Further, the camera functions as a detection unit which detects white lines provided on the right and the left of a lane on which the vehicle is traveling, and transmits imaging information obtained by imaging the white lines to the ECU 10. The white line may be either of a solid line and a dashed line and may be either of a single line and a composite line.

The camera is provided on, for example, the back side of a front windshield of the vehicle. The camera may be a monocular camera or may be a stereo camera. The stereo camera has two imaging units disposed so as to reproduce a binocular parallax. Information in a depth direction is also included in the imaging information of the stereo camera. In a case of using the stereo camera, the camera functions as a detector which detects a three-dimensional object which includes a preceding vehicle, an obstacle, a pedestrian, or the like.

The radar detects an object around the vehicle by using radio waves (for example, millimeter waves). The radar transmits radio waves to the surroundings of the vehicle and receives the radio waves reflected by an object, thereby detecting the object. The radar transmits information about the detected object to the ECU 10.

The LIDAR detects an object around the vehicle by using light. The LIDAR sends light to the surroundings of the vehicle and receives the light reflected by an object, thereby measuring a distance to a reflection point and detecting the object. The LIDAR transmits information about the detected object to the ECU 10. The camera, the radar, and the LIDAR need not necessarily be provided overlappingly.

The GPS receiving unit 3 receives signals from three or more GPS satellites, thereby measuring the position of the vehicle (for example, the latitude and longitude of the vehicle). The GPS receiving unit 3 transmits information about the measured position of the vehicle to the ECU 10. In addition, instead of the GPS receiving unit 3, other means capable of identifying the latitude and longitude of the vehicle may be used. Further, for a collation of the measurement result of the sensor with map information which will be described later, it is preferable to be provided with a function of measuring the azimuth of the vehicle.

The vehicle internal information sensor 4 is detection equipment which detects a traveling state of the vehicle. The vehicle internal information sensor 4 includes a vehicle speed sensor. The vehicle speed sensor is a detector which detects the speed of the vehicle. As the vehicle speed sensor, for example, a wheel speed sensor which is provided at a wheel of the vehicle or a member such as a drive shaft rotating integrally with or synchronously with the wheels and detects the rotational speed of the wheels is used. The vehicle speed sensor transmits information about the detected vehicle speed (wheel speed information) to the ECU 10.

The vehicle internal information sensor 4 may include at least one of an acceleration sensor and a yaw rate sensor. The acceleration sensor is a detector which detects the acceleration of the vehicle. The acceleration sensor includes, for example, a forward and backward acceleration sensor which detects the acceleration in a frontward-backward direction of the vehicle, and a lateral acceleration sensor which detects the lateral acceleration of the vehicle. The acceleration sensor transmits, for example, information about the acceleration of the vehicle to the ECU 10. The yaw rate sensor is a detector which detects a yaw rate (rotational angular velocity) around a vertical axis of the center of gravity of the vehicle. As the yaw rate sensor, for example, a gyro sensor can be used. The yaw rate sensor transmits information about the detected yaw rate of the vehicle to the ECU 10.

The map database 5 is a database provided with map information. The map database is formed in, for example, a HDD [Hard Disk Drive] mounted on the vehicle. For example, position information of a road, information about a road shape (for example, the types of a curve and a straight portion, the curvature of a curve, and the like), and position information of an intersection and a branch point are included in the map information. In addition, the map database may be stored in a computer of a facility such as an information processing center capable of communicating with the vehicle.

The navigation system 6 is a device which performs guidance to a destination set by the driver of the vehicle to the driver of the vehicle. The navigation system 6 calculates a route on which the vehicle is traveling, based on the position information of the vehicle measured by the GPS receiving unit 3 and the map information of the map database 5. The route may be a route in which a suitable lane is specified in sections of a plurality of lanes. The navigation system 6 calculates, for example, a target route from the position of the vehicle to a destination and performs the notification of the target route to the driver by display of a display and an audio output of a speaker. The navigation system 6 transmits, for example, information about the target route of the vehicle to the ECU 10. In addition, the navigation system 6 may be stored in a computer of a facility such as the information processing center capable of communicating with the vehicle.

The HMI 7 is an interface for performing the output and the input of information between an occupant (including a driver) of the vehicle and the vehicle control device 1. The HMI 7 is provided with, for example, a display panel for displaying image information to the occupant, a speaker for an audio output, operation buttons or a touch panel for allowing the occupant to perform an input operation, and the like. The HMI 7 may perform the output of information to the occupant by using a portable information terminal wirelessly connected thereto and may accept an operation input by the occupant by using the portable information terminal.

A steering display unit 71 which displays a steering control state in the steering and braking control is provided in the HMI 7. The steering display unit 71 is a display unit which displays steering display corresponding to a steering direction of the steering and braking control in a case where avoidance of a collision with an object around the vehicle cannot be performed in the braking control, and, for example, a display such as a monitor can be used. As the steering display, for example, a steering wheel mark schematically depicting a steering wheel, and a steering direction mark indicating a steering direction by an arrow can be used (refer to a steering wheel mark H and a steering direction mark A of FIG. 3). The steering display unit 71 displays the steering wheel mark with it rotated in accordance with the steering direction and displays the steering direction mark (for example, an arrow mark) in accordance with the steering direction. The steering display is performed by the steering display unit 71, whereby the driver can become aware of the steering control status of the vehicle, and thus it is possible to suppress a sense of discomfort due to the steering and braking control for the behavior of the vehicle. In addition, the steering display unit 71 may be steering display other than the mark display or may be, for example, character display. In this case, it is favorable if the effect that it is in the steering control to the right or the effect that it is in the steering control to the left is displayed according to the steering direction of the steering and braking control.

The actuator 8 is a device which executes vehicle control of the vehicle. The actuator 8 includes at least a throttle actuator, a brake actuator, and a steering actuator. The throttle actuator controls the intake amount of air to an engine (the degree of throttle opening) according to a control signal from the ECU 10, thereby controlling the drive force of the vehicle.

The brake actuator controls a brake system according to a control signal from the ECU 10, thereby controlling a braking force which is applied to the wheels of the vehicle. As the brake system, for example, a hydraulic brake system can be used. The steering actuator controls the driving of an assist motor which controls a steering torque of an electric power steering system, according to a control signal from the ECU 10. In this way, the steering actuator controls a steering torque which is output to the vehicle, for example, by adjusting the output of an assist torque with respect to a steering torque of the driver. The steering actuator may control the steering torque which is output to the vehicle, regardless of the steering torque of the driver.

The direction indicator 21 is a lighting device which informs the outside of the vehicle of the steering direction of the vehicle, and is referred to as a blinker or a turn signal. The direction indicators 21 are respectively provided at, for example, the right and left of the front and the right and left of the rear of the vehicle and are turned on by a lighting operation of the driver. The direction indicator 21 is controlled by a control signal from the ECU 10 so as to flash when the steering and braking control for collision avoidance is performed.

The hazard flashing indicator 22 is a lighting device which informs the outside of an emergency stop state of the vehicle and is referred to as a hazard lamp, a hazard indicator, or a hazard flasher. The hazard flashing indicators 22 are respectively provided at, for example, the right and left of the front and the right and left of the rear of the vehicle and are operated so as to flash by a lighting operation of the driver. The hazard flashing indicators 22 are controlled by a control signal from the ECU 10 so as to flash when the vehicle has been stopped by the braking control or the steering and braking control. In addition, when the vehicle has been stopped by the braking control or the steering and braking control, a flashing operation may be performed by using brake lamps as the hazard flashing indicators 22. Further, the hazard flashing indicator 22 may be used to share the direction indicator 21.

The ECU 10 is provided with an external situation recognition unit 11, a vehicle position recognition unit 12, a traveling state recognition unit 13, a collision determination unit 14, a braking avoidance determination unit 15, a traveling plan generation unit 16, a display control unit 17, a driving control unit 18, and a lighting control unit 19.

The external situation recognition unit 11 recognizes an external situation of the vehicle, based on the detection result (for example, the imaging information of the camera, the object information of the radar, the object information of the LIDAR, or the like) of the vehicle external information sensor 2. The external situation includes, for example, the position of the white line of a driving lane with respect to the vehicle, the position of the center of the lane and a road width, the shape of a road (for example, the curvature of the driving lane, a gradient change or undulation of a road surface effective for a prospect estimate of the vehicle external information sensor 2, or the like), or a situation of an object around the vehicle (for example, the distance between the vehicle and the object, the position of the object with respect to the vehicle, the moving direction of the object with respect to the vehicle, the relative speed of the object with respect to the vehicle, or the like). Further, the accuracy of the position and the direction of the vehicle, which are acquired by the GPS receiving unit 3 or the like, may be supplemented by collating the detection result of the vehicle external information sensor 2 with the map information. The external situation recognition unit 11 functions as an object detection unit which detects an object around the vehicle. As the object, for example, other vehicles (including a motorcycle), a pedestrian, a bicycle, an obstacle, or the like corresponds thereto. The recognition information of the external situation recognition unit 11 is input to, for example, the collision determination unit 14, the braking avoidance determination unit 15, and the traveling plan generation unit 16.

The vehicle position recognition unit 12 recognizes the position of the vehicle (hereinafter referred to as a “vehicle position”) on a map, based on the position information of the vehicle received by the GPS receiving unit 3 and the map information of the map database 5. In addition, the vehicle position recognition unit 12 may recognize the vehicle position which is used in the navigation system 6, by acquiring it from the navigation system 6. In a case where the vehicle position of the vehicle can be measured by a sensor installed on the outside such as a road, the vehicle position recognition unit 12 may acquire the vehicle position from the sensor by communication. The recognition information of the vehicle position recognition unit 12 is input to, for example, the collision determination unit 14, the braking avoidance determination unit 15, and the traveling plan generation unit 16.

The traveling state recognition unit 13 recognizes a traveling state of the vehicle, based on the detection result of the vehicle internal information sensor 4 (for example, the vehicle speed information of the vehicle speed sensor, the acceleration information of the acceleration sensor, the yaw rate information of the yaw rate sensor, or the like). For example, a vehicle speed, acceleration, a yaw rate are included in the traveling state of the vehicle. Further, the traveling state recognition unit 13 may recognize a traveling direction of the vehicle, based on a temporal change in the position of the vehicle. The recognition information of the traveling state recognition unit 13 is input to, for example, the collision determination unit 14, the braking avoidance determination unit 15, and the traveling plan generation unit 16.

The collision determination unit 14 determines whether or not there is a possibility that the vehicle may collide with the object detected by the external situation recognition unit 11. The collision determination unit 14 calculates collision time TTC [Time to Collision] with respect to the detected object. The calculation of the collision time TTC is performed, for example, by dividing the distance from the vehicle to the object by the relative speed. Further, the collision determination unit 14 determines whether or not the calculated collision time TTC is less than or equal to a threshold value TTCth, thereby determining a possibility that the vehicle may collide with the object. That is, in a case where the collision time TTC is not less than or equal to the threshold value TTCth, the collision determination unit 14 determines that there is no possibility that the vehicle may collide with the object. On the other hand, in a case where the collision time TTC is less than or equal to the threshold value TTCth, the collision determination unit 14 determines that there is a possibility that the vehicle may collide with the object. As the threshold value TTCth, for example, a setting value which is set in the ECU 10 in advance is used. The determination information about a collision possibility is input to, for example, the braking avoidance determination unit 15, and the traveling plan generation unit 16.

The braking avoidance determination unit 15 determines whether or not a collision can be avoided by the braking control of the vehicle, based on the detection result of the object detection and the vehicle speed of the vehicle, in a case where a determination that there is a possibility that the vehicle may collide with the object is made by the collision determination unit 14. For example, the braking avoidance determination unit 15 calculates a braking distance until the vehicle stops, based on the vehicle speed of the vehicle and allowable deceleration by the braking control. The allowable deceleration is, for example, the maximum deceleration (for example, a setting value) allowed to the vehicle control device 1 in emergency avoidance. The braking avoidance determination unit 15 determines that a collision can be avoided by only the braking control, in a case where the braking distance is less than the distance from the vehicle to the object, and determines that a collision cannot be avoided by only the braking control, in a case where the braking distance is greater than or equal to the distance to the object. The determination information of the braking avoidance determination unit 15 is input to, for example, the display control unit 17 and the traveling plan generation unit 16.

The traveling plan generation unit 16 generates a traveling plan of the braking control, for example, in a case where a determination that a collision can be avoided by the braking control is made by the braking avoidance determination unit 15. At least a target speed pattern is included in the traveling plan of the braking control. The traveling plan generation unit 16 generates the target speed pattern, based on the traveling state of the vehicle (for example, the vehicle speed of the vehicle) recognized in the traveling state recognition unit 13. The target speed pattern is, for example, data of a target speed for each predetermined internal or for each predetermined time in the traveling direction (for example, a direct advance direction) of the vehicle. The traveling plan generation unit 16 generates the target speed pattern so as to avoid a collision of the vehicle with the object by stopping the vehicle. In addition, the vehicle control device 1 may perform the braking control that decelerates the vehicle at allowable deceleration set in advance, without generating the traveling plan of the braking control.

The traveling plan generation unit 16 generates a traveling plan of the steering and braking control, for example, in a case where a determination that a collision cannot be avoided by the braking control is made by the braking avoidance determination unit 15. A target pathway and a target speed pattern are included in the traveling plan of the steering and braking control. The traveling plan generation unit 16 generates the target pathway of the vehicle, based on, for example, the vehicle position recognized in the vehicle position recognition unit 12, the external situation of the vehicle recognized in the external situation recognition unit 11, and the traveling state of the vehicle recognized in the traveling state recognition unit 13.

Specifically, the traveling plan generation unit 16 performs, for example, processing of searching a pathway candidate for generating the target pathway. The search processing is processing of generating a plurality of pathway candidates each having the changed traveling direction of the vehicle, and searching a pathway candidate in which a collision with the object can be avoided. For example, the traveling plan generation unit 16 generates a plurality of pathway candidates each having the changed traveling direction of the vehicle and determines whether or not a collision with the object can be avoided. The pathway candidate is generated as a plurality of pathways in which, for example, the traveling direction of the vehicle is changed every ±0.1 degrees. The pathway candidate may be limited to the inside of the lane on which the vehicle is traveling.

In a case where a pathway candidate in which a collision with the object can be avoided could be generated, the traveling plan generation unit 16 sets the pathway candidate as the target pathway. For example, in a case where there are a plurality of pathway candidates in which collision avoidance is possible, the traveling plan generation unit 16 sets a pathway candidate farthest from the object as the target pathway. This target pathway becomes a target pathway in the steering and braking control to avoid a collision by both the steering of the vehicle and the braking of the vehicle. That is, the target pathway becomes a pathway in which the vehicle decelerates and stops while avoiding a collision with the object by the steering and braking control. This target pathway may be generated within the lane on which the vehicle is traveling. In this case, the steering and braking control becomes possible in which the vehicle travels along the target pathway generated within the lane, thereby avoiding a collision, and contact with a vehicle traveling on the neighboring lane is avoided.

The traveling plan generation unit 16 generates a target speed pattern along the target pathway, based on, for example, the traveling state of the vehicle (the vehicle speed of the vehicle) recognized by the traveling state recognition unit 13. The target speed pattern is, for example, data of a target speed for each predetermined internal or for each predetermined time on the target pathway. The traveling plan generation unit 16 generates a target speed pattern in which the vehicle is stopped with a collision of the vehicle with the object avoided.

The traveling plan generation unit 16 generates a traveling plan of the braking control in a case where a pathway candidate in which a collision with the object can be avoided could not be generated. The braking control in this case is braking control for collision mitigation. The traveling plan generation unit 16 generates a traveling plan of the braking control for collision mitigation, for example, in the same manner as the traveling plan of the braking control for collision avoidance.

The traveling plan generation unit 16 may determine whether or not the steering and braking control of the vehicle according to the traveling plan is possible, in a case where a pathway candidate in which a collision with the object can be avoided can be generated and the traveling plan of the steering and braking control is generated. The traveling plan generation unit 16 determines whether or not the steering and braking control of the vehicle according to the traveling plan is possible, based on, for example, the vehicle position recognized in the vehicle position recognition unit 12, the external situation of the vehicle recognized in the external situation recognition unit 11, and the traveling state of the vehicle recognized in the traveling state recognition unit 13. For example, in a case where disturbance which is not considered as the external situation is recognized, the traveling plan generation unit 16 determines that the steering and braking control of the vehicle along the target pathway is not possible. The disturbance which is not considered as the external situation is, for example, a decrease in road surface friction due to rain. The road surface friction can be inferred from, for example, the captured image of the camera by a well-known technique.

The traveling plan generation unit 16 generates a traveling plan of the braking control in a case where it is determined that the steering and braking control of the vehicle according to the traveling plan is not possible. The braking control in this case is braking control for collision mitigation.

The display control unit 17 causes steering display corresponding to the steering direction of the steering and braking control for collision avoidance to be displayed on the steering display unit 71, in a case where a determination that a collision cannot be avoided by the braking control is made by the braking avoidance determination unit 15 and when the traveling plan of the steering and braking control has been generated by the traveling plan generation unit 16. For example, the display control unit 17 outputs a control signal to the steering display unit 71, thereby causing steering display corresponding to the steering direction of the steering and braking control to be displayed on the steering display unit 71, in a case where a determination that a collision cannot be avoided by the braking control is made by the braking avoidance determination unit 15.

In addition, the ECU 10 may have a warning control unit (not shown) which performs warning control processing on the driver in a case where a determination that there is a possibility that the vehicle may collide with the object is made by the collision determination unit 14. The warning control unit performs a warning operation by outputting a control signal to the HMI 7, for example, in a case where it is determined that there is a possibility that the vehicle may collide with the object. As the warning operation, sounding of a buzzer, the notification of a warning message by a speaker, warning display by a monitor, lighting or flashing of a warning lamp, or the like corresponds thereto.

The driving control unit 18 executes traveling control of the vehicle, based on the traveling plan generated in the traveling plan generation unit 16. For example, the driving control unit 18 executes the braking control of the vehicle in a case where there is a possibility of a collision with the object and a case where a collision can be avoided by the braking control (a case where the traveling plan of the braking control has been generated by the traveling plan generation unit 16). On the other hand, the driving control unit 18 executes the steering and braking control to avoid a collision by both the steering of the vehicle and the braking of the vehicle, in a case where a collision cannot be avoided by only the braking control (a case where the traveling plan of the steering and braking control has been generated by the traveling plan generation unit 16). In the steering and braking control, the steering and the braking need not necessarily be started at the same time, and the braking may be the first or the steering may be the first. It is favorable if the steering and braking control is control of causing the vehicle to travel and stop by the combination of the braking with the steering for avoidance of a collision with the object. The driving control unit 18 outputs a control signal corresponding to the traveling plan to the actuator 8. In this way, the driving control unit 18 controls the traveling of the vehicle such that the vehicle travels according to the traveling plan.

The lighting control unit 19 performs operation control of the direction indicator 21 and the hazard flashing indicator 22. That is, the lighting control unit 19 outputs a control signal to the direction indicator 21 and the hazard flashing indicator 22, thereby controlling the operation of the direction indicator 21 and the hazard flashing indicator 22. For example, the lighting control unit 19 starts the flashing of the direction indicator 21 in accordance with the steering direction of the steering and braking control in a case where a determination that a collision cannot be avoided by the braking control is made by the braking avoidance determination unit 15, and flashes the hazard flashing indicators 22 in a case where the vehicle has been stopped by the steering and braking control. That is, the lighting control unit 19 performs control so as to flash the left direction indicator 21 in a case where the vehicle is steered to the left by the steering and braking control, and performs control so as to flash the right direction indicator 21 in a case where the vehicle is steered to the right by the steering and braking control. Further, the lighting control unit 19 performs control so as to flash the hazard flashing indicators 22 in a case where the vehicle has stopped. The lighting control unit 19 ends the flashing control of the direction indicator 21 in a case where the vehicle has stopped.

In addition, the external situation recognition unit 11, the vehicle position recognition unit 12, the traveling state recognition unit 13, the collision determination unit 14, the braking avoidance determination unit 15, the display control unit 17, the traveling plan generation unit 16, the driving control unit 18, and the lighting control unit 19 described above may be configured by introducing software or a program which implements the respective functions, into the ECU 10. Further, some or all of them may be respectively configured by individual electronic control units.

Next, an operation of the vehicle control device 1 according to this embodiment will be described.

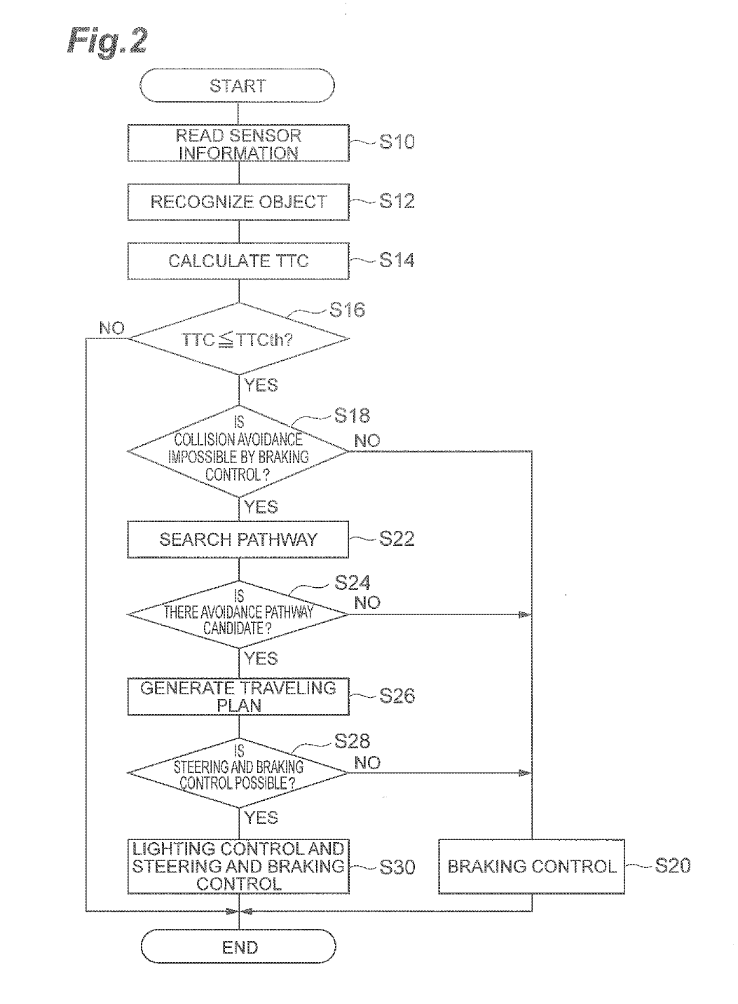

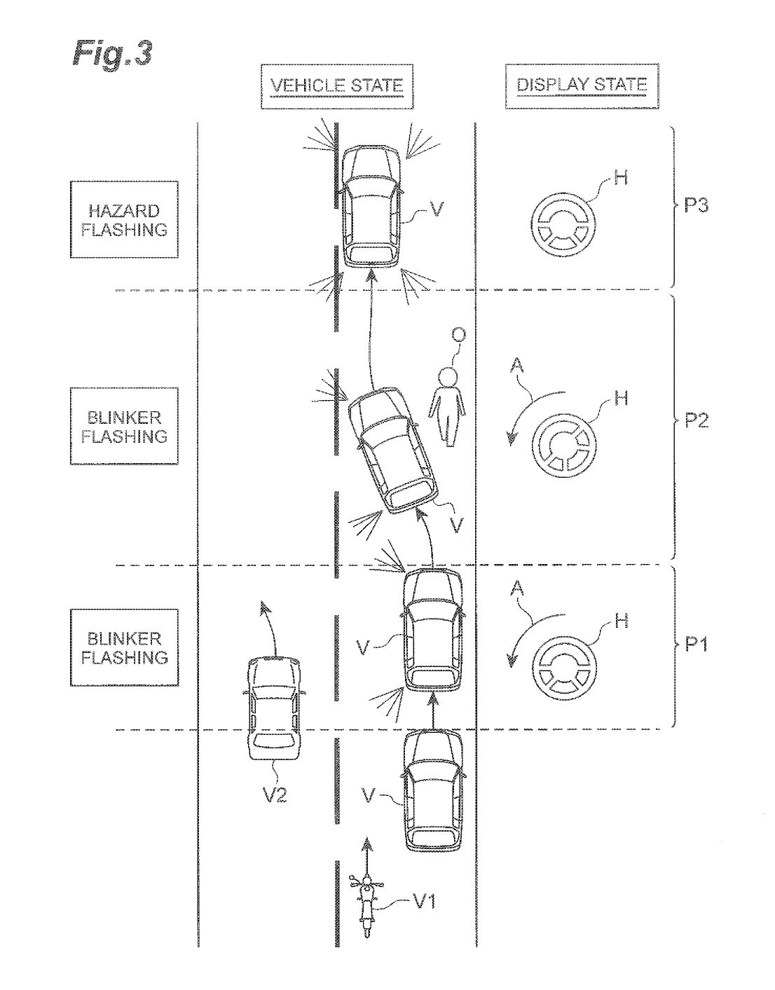

FIG. 2 is a flowchart showing control processing in the vehicle control device 1 according to this embodiment. The control processing is performed, for example, in a case where the vehicle is traveling, and is started along with the start of the engine of the vehicle. Further, the control processing is executed by, for example, the ECU 10.

As shown in S10 of FIG. 2, first, processing of reading the sensor information is performed. This processing is processing of reading, for example, the information of the vehicle external information sensor 2, the GPS receiving unit 3, the vehicle internal information sensor 4, and the navigation system 6. Then, processing proceeds to S12 and processing of recognizing an object is performed. The object recognition processing is processing of recognizing information about the position of an object around the vehicle detected by the vehicle external information sensor 2, the distance between the object and the vehicle, and the relative speed between the object and the vehicle.

Then, processing proceeds to S14 and processing of calculating the collision time TTC with the object is performed. The calculation processing is processing of calculating the collision time TTC between the object recognized in S12 and the vehicle. For example, the external situation recognition unit 11 calculates the collision time TTC by dividing the distance from the vehicle to the object by the relative speed.

Then, processing proceeds to S16 and whether or not the collision time TTC calculated in S14 is less than or equal to the threshold value TTCth is determined. This determination processing is processing of determining whether there is a possibility that the vehicle may collide with the object. For example, the collision determination unit 14 determines that there is no possibility that the vehicle may collide with the object, in a case where the collision time TTC is not less than or equal to the threshold value TTCth, and determines that there is a possibility that the vehicle may collide with the object, in a case where the collision time TTC is less than or equal to the threshold value TTCth. As the threshold value TTCth, it is favorable if the setting value which is set in the ECU 10 in advance is used.

In a case where a determination that the collision time TTC is not less than or equal to the threshold value TTCth is made in S16, it is determined that there is no possibility of collision with the object, and a series of control processing of FIG. 2 is ended. Thereafter, the ECU 10 starts the processing from S10 again. On the other hand, in a case where a determination that the collision time TTC is less than or equal to the threshold value TTCth is made in S16, whether a collision with the object cannot be avoided by the braking control is determined (S18). For example, the braking avoidance determination unit 15 calculates a braking distance, based on the vehicle speed of the vehicle and the deceleration by the braking control, and determines that a collision can be avoided by the braking control, in a case where the braking distance is less than the distance to the object, and determines that a collision cannot be avoided by the braking control, in a case where the braking distance is greater than or equal to the distance to the object.

In a case where a determination that a collision with the object can be avoided by the braking control is made in S18, the braking control for collision avoidance is performed (S20). The braking control for collision avoidance is processing of avoiding a collision with the object by only the braking control without using the steering control. That is, the driving control unit 18 outputs a control signal to the actuator 8 of a brake, thereby executing the braking control of the vehicle. At this time, the lighting control unit 19 turns on or flashes, for example, brake lamps which are provided at a rear portion of the vehicle.

In a case where a determination that a collision with the object cannot be avoided by the braking control is made in S18, search of a pathway candidate in which a collision with the object can be avoided is performed (S22). For example, the traveling plan generation unit 16 generates a plurality of pathway candidates each having the changed traveling direction of the vehicle.

Then, processing proceeds to S24 and whether or not there is a pathway candidate in which a collision with the object can be avoided is determined. This determination processing is processing of determining whether or not there is a pathway candidate in which a collision with the object can be avoided. For example, the traveling plan generation unit 16 determines whether or not there is a pathway candidate in which a collision with the object can be avoided, with respect to the pathway candidates generated in S22. Then, in a case where a pathway candidate in which a collision with the object can be avoided could be generated, the traveling plan generation unit 16 determines that there is a pathway candidate in which a collision with the object can be avoided. On the other hand, in a case where a pathway candidate in which a collision with the object can be avoided cannot be generated, the traveling plan generation unit 16 determines that there is no pathway candidate in which a collision with the object can be avoided.

In a case where a determination that there is no pathway candidate is made in S24, the braking control for collision mitigation is performed in S20. On the other hand, in a case where a determination that there is a collision avoidance pathway is made in S24, the traveling plan of the steering and braking control is generated (S26). The traveling plan generation unit 16 sets the pathway candidate in which a collision with the object can be avoided, as the target pathway of the vehicle. For example, in a case where there are a plurality of pathway candidates in which a collision can be avoided, the traveling plan generation unit 16 sets the pathway candidate farthest from the object as the target pathway of the vehicle. The traveling plan generation unit 16 generates a target speed pattern along the target pathway, based on, for example, the traveling state of the vehicle (the vehicle speed of the vehicle) recognized in the traveling state recognition unit 13. The traveling plan generation unit 16 generates the traveling plan of the steering and braking control which includes the target pathway and the target speed pattern.

In a case where the traveling plan has been generated in S26, whether or not the steering and braking control of the vehicle according to the traveling plan is possible is determined (S28). The traveling plan generation unit 16 determines whether or not the steering and braking control of the vehicle according to the traveling plan is possible, based on, for example, the vehicle position recognized in the vehicle position recognition unit 12, the external situation of the vehicle recognized in the external situation recognition unit 11, and the traveling state of the vehicle recognized in the traveling state recognition unit 13.

In a case where a determination that the steering and braking control of the vehicle according to the traveling plan is not possible is made in S28, the braking control for collision mitigation is performed in S20. In a case where a determination that the steering and braking control of the vehicle according to the traveling plan is possible is made in S28, the lighting control and the steering and braking control are executed (S30).

The lighting control processing is processing of controlling the operations of the direction indicator 21 and the hazard flashing indicator 22. The steering and braking control processing is processing of performing avoidance of a collision with the object by both the steering and the braking of the vehicle. The lighting control processing and the steering and braking control processing may be started at the same time, and the steering and braking control processing may be started after the lighting control processing is started. For example, as the lighting control processing, the lighting control unit 19 outputs a control signal to the direction indicator 21 and the hazard flashing indicator 22, thereby controlling the operations of the direction indicator 21 and the hazard flashing indicator 22. The direction indicator 21 is flashed in accordance with the steering direction of the steering and braking control, and the hazard flashing indicators 22 are flashed in a case where the vehicle has been stopped by the steering and braking control.

Further, as the steering and braking control processing, the driving control unit 18 outputs a control signal to the actuator 8, thereby actuating the brake actuator and the steering actuator so as to cause the vehicle to travel along the target pathway. The steering and braking control processing is not limited to a case of simultaneously performing the braking and the steering, and the braking may be the first or the steering may be the first. Further, steering display processing may be performed along with the lighting control processing and the steering and braking control processing. The steering display processing is processing of informing the driver that the steering control is being performed, through the steering display. That is, the display control unit 17 outputs a control signal to the steering display unit 71, thereby causing the steering display unit 71 to perform steering display. Specific processing contents will be described later.

FIG. 3 shows the behavior of the vehicle at the time of the execution of the lighting control processing and the steering and braking control processing, a flashing control state, and a steering display state to the driver. P1 of FIG. 3 shows a situation at the time of the start of the steering and braking control in the steering and braking control of a vehicle V. The vehicle control device 1 starts the lighting control processing according to the start of, for example, the steering and braking control, and flashing control (blinker flashing) of the direction indicator 21 corresponding to the steering direction of the steering and braking control is performed. In FIG. 3, the steering direction is a leftward direction and the flashing control of the left direction indicator 21 is performed. Further, at this time, in the steering display unit 71, the steering wheel mark H and the steering direction mark A are displayed to the driver. The steering wheel mark H is a mark indicating that the steering and braking control is being executed, and is displayed in a state where it has been rotated according to the steering state of the vehicle V in the steering and braking control. The steering direction mark A is an arrow mark and indicates the steering direction. By performing the flashing control of the vehicle V, it is possible to inform other vehicles V1 and V2 of the surroundings of the steering direction of the vehicle V by the steering and braking control. Further, by showing the steering display such as the steering wheel mark H during the steering and braking control, it is possible to inform the driver that the steering and braking control is being executed.

P2 of FIG. 3 shows a situation in which the steering and braking control to avoid a collision with an object O (here, a pedestrian) is being executed. In P2, the vehicle V decelerates while traveling so as to avoid the object O. The lighting control processing also continues to be executed, and thus the flashing control is performed. The steering wheel mark H is displayed in a state where it has been rotated according to the steering situation of the vehicle V.

P3 of FIG. 3 shows a situation in which the vehicle V has been stopped by the steering and braking control. At this time, the hazard flashing indicators 22 provided at the front and rear and the right and left of the vehicle V are actuated by the lighting control processing, and the flashing control (hazard flashing) is performed. In the steering display unit 71, the steering wheel mark H is displayed and the steering direction mark A is turned off. By performing the flashing control of the hazard flashing indicators 22 of the vehicle V, it is possible to inform the other vehicles V1 and V2 of the surroundings that the vehicle V is in an emergency stop. Further, as shown in FIG. 3, by setting the target pathway to avoid a collision with the object O, within the lane on which the vehicle V travels, and performing the steering and braking control, contact with the other vehicle V2 which travels on the neighboring lane can be avoided.

Further, in FIG. 2, if the processing of S30 is finished, a series of control processing of FIG. 2 is ended. In addition, in a series of control processing of FIG. 2, as long as it does not affect the control result, the execution of some of the control processing in FIG. 2 may be omitted. For example, the processing of S28 is not essential. Further, as long as it does not affect the control result, the order of the control processing may be changed and another control processing may be added.

As described above, according to the vehicle control device 1 according to this embodiment, when the steering and braking control of the vehicle is performed in order to avoid a collision with an object, the direction indicator is flashed according to the steering direction of the vehicle and the hazard flashing indicators are flashed in a case where the vehicle has stopped. Therefore, it is possible to inform the surroundings of the vehicle of the steering direction of the vehicle of the steering and braking control through the flashing of the direction indicator, and it is possible to inform the surroundings of the vehicle that the vehicle is in an emergency stop, through the flashing of the hazard flashing indicators.

Further, in the vehicle control device 1 according to this embodiment, by generating the target pathway for avoiding a collision with an object, within the lane on which the vehicle is traveling, and performing the steering and braking control in accordance with the target pathway, driving of the vehicle while avoiding contact with a vehicle which is being driven on a neighboring lane becomes possible.

Further, in the vehicle control device 1 according to this embodiment, when the steering and braking control of the vehicle is performed in order to avoid a collision with an object, by causing steering display to be displayed on a display in the vehicle in accordance with the steering direction of the steering and braking control, the driver can become aware of the steering control situation of the vehicle, and thus it is possible to suppress a sense of discomfort due to the steering and braking control for the behavior of the vehicle.

In addition, the embodiment described above is for describing an embodiment of the vehicle control device according to the present disclosure, and the vehicle control device according to the present disclosure is not limited to the description of the above-described embodiment. The vehicle control device according to the present disclosure includes modifications applied to the vehicle control device according to the above-described embodiment so as not to change the gist as set forth in each of the claims, or may be applied to others.

For example, the vehicle control device 1 according to the embodiment described above has been described with respect to a case of being applied to a vehicle for manual driving. However, the vehicle control device according to the present disclosure may be applied to a vehicle with automatic driving control.

What is claimed is:

1. A vehicle control device comprising:
an object detection unit configured to detect an object around a vehicle;
a collision determination unit configured to determine whether or not there is a possibility that the vehicle may collide with the object detected by the object detection unit;
a braking avoidance determination unit configured to determine whether or not a collision can be avoided by braking control of the vehicle, based on a detection result of the object detection unit and a vehicle speed of the vehicle, in a case where a determination that there is a possibility that the vehicle may collide with the object is made by the collision determination unit;
a driving control unit configured to perform the braking control without the steering control in a case where a determination that the collision can be avoided by the braking control is made by the braking avoidance determination unit, and to perform steering and braking control to avoid the collision by both steering of the vehicle and braking of the vehicle, in a case where a determination that the collision cannot be avoided by the braking control is made by the braking avoidance determination unit; and
a lighting control unit configured to start flashing a direction indicator of the vehicle corresponding to a steering direction of the steering and braking control in a case where a determination that the collision cannot be avoided by the braking control is made by the braking avoidance determination unit, and to flash hazard flashing indicators of the vehicle in a case where the vehicle has been stopped by the steering and braking control.

2. The vehicle control device according to claim 1, further comprising:
a traveling plan generation unit configured to generate a target pathway for avoiding a collision of the vehicle with the object, within a lane on which the vehicle is traveling, in a case where a determination that the collision cannot be avoided by the braking control is made by the braking avoidance determination unit,
wherein the driving control unit is configured to perform the steering and braking control in accordance with the target pathway.

3. The vehicle control device according to claim 1, further comprising:
a display control unit configured to cause steering display corresponding to a steering direction of the steering and braking control by the driving control unit to be displayed on a display in the vehicle in a case where a determination that the collision cannot be avoided by the braking control is made by the braking avoidance determination unit.

4. A vehicle control device comprising:
a detector configured to detect an object around a vehicle; and
an electronic control unit (ECU) programmed to:
determine whether or not there is a possibility that the vehicle may collide with the object detected by the detector;
determine whether or not a collision can be avoided by braking control of the vehicle, based on a detection result of the detector and a vehicle speed of the vehicle, in a case where a determination is made that there is a possibility that the vehicle may collide with the object;
perform the braking control without the steering control in a case where a determination is made that the collision can be avoided by the braking control, and perform steering and braking control to avoid the collision by both steering of the vehicle and braking of the vehicle, in a case where a determination is made that the collision cannot be avoided by the braking control; and
start flashing a direction indicator of the vehicle corresponding to a steering direction of the steering and braking control in a case where a determination is made that the collision cannot be avoided by the braking control, and start flashing hazard flashing indicators of the vehicle in a case where the vehicle has been stopped by the steering and braking control.

5. The vehicle control device according to claim 4, wherein the ECU is further programmed to:
generate a target pathway for avoiding a collision of the vehicle with the object, within a lane on which the vehicle is traveling, in a case where a determination is made that the collision cannot be avoided by the braking control;
perform the steering and braking control in accordance with the target pathway.

6. The vehicle control device according to claim 4, wherein the ECU is further programmed to cause steering display corresponding to a steering direction of the steering and braking control to be displayed on a display in the vehicle in a case where a determination is made that the collision cannot be avoided by the braking control.

7. The vehicle control device according to claim 4, wherein the direction indicator includes a left direction indicator and a right direction indicator, and
wherein the ECU is further programmed to flash the left direction indicator in a case where the vehicle is steered to the left by the steering and braking control, and flash the right direction indicator in a case where the vehicle is steered to the right by the steering and braking control.

8. The vehicle control device according to claim 4, wherein the ECU is further programmed to end the flashing control of the direction indicator in a case where the vehicle has stopped.
